(19) United States
(12) Patent Application Publication
(10) Pub. No.: US 2008/0119604 A1
(43) Pub. Date: May 22, 2008

(54) Non-or reduced PVC copolymer vinyl composition tile

(76) Inventor: Thomas P. Greenawalt, Lancaster, PA (US)

Correspondence Address: ARMSTRONG WORLD INDUSTRIES, INC.;LEGAL DEPARTMENT, P. O. BOX 3001, LANCASTER, PA, 17604-3001, US

(21) Appl. No.: 11/985,932

(22) Filed: Nov. 19, 2007

Related U.S. Application Data
(60) Provisional application No. 60/860,081, filed on Nov. 20, 2006.

(51) Int. Cl. C08L 33/08

(52) U.S. Cl. 524/522

(57) ABSTRACT

A fused composition and a vinyl composition tile made from the fused composition have less PVC/PVAc copolymer than typical VCT. The fused composition consists essentially of binder, filler and optional pigment, wherein the binder consists essentially of PVC homopolymer, acrylic polymer, plasticizer and stabilizer. The binder includes a reduced amount of PVC/PVAc or may be free of PVC/PVAc. The composition is highly filled, having at least 77% by weight of filler and pigment. Polyvinyl butryal may replace some of the homopolymer and plasticizer. Post consumer or post industrial filler or binder may be used.

### BACKGROUND OF THE INVENTION

This invention relates to a fused composition and a vinyl composition tile (“VCT”) consisting essentially of the fused composition, wherein the fused composition has less polyvinyl chloride/polyvinyl acetate copolymer than typical VCT. The fused composition consists essentially of binder, filler and optional pigment, wherein the binder consists essentially of polyvinyl chloride homopolymer (“PVC”), acrylic polymer, plasticizer and stabilizer,

In some embodiments, the binder includes a reduced amount of polyvinyl chloride/polyvinyl acetate copolymer (“PVC/PVAc”). In other embodiments, the binder is has no or substantially no PVC/PVAc, in which case the binder is free or substantially free of PVC/PVAc. The filler and pigment comprises at least 77% by weight of the composition.

In some embodiments, polyvinyl butryal (“PVB”) replaces some of the homopolymer and plasticizer. Therefore, in those embodiments the amount of PVC in the form of homopolymer and copolymer is further reduced.

### SUMMARY OF THE INVENTION

An object of the invention is to provide a fused composition having no or substantially no PVC/PVAc, or reduced amounts of PVC/PVAc.

Another object of the invention is to provide a VCT comprising a fused composition having no or substantially no PVC/PVAc, or reduced amounts of PVC/PVAc.

An additional object of the invention is to provide a fused composition and VCT comprising the composition having no or reduced amounts of PVC/PVAc in which polyvinyl butryal (“PVB”) replaces some of the PVC and plasticizer.

### DETAILED DESCRIPTION OF THE INVENTION

The present inventors have used acrylic esters (“acrylates”) to replace polyvinyl chloride/polyvinyl acetate copolymer in vinyl composition tile at the bench level and in scale-up tests. Modified VCT having no or substantially no PVC/PVAc was successfully made. The balance of the binder consisted of PVC homopolymer resin, phthalate or other plasticizers, and stabilizers. Other additives included tackifier resins, such as hydrocarbon resin and alpha-methyl styrene resin, acrylic impact modifiers, polymeric fillers, and post consumer or post industrial fillers or binders. Plant testing confirmed the viability of the formula to produce floor tile with properties equivalent to those using PVC/PVAc copolymer resin in the formula and is in commercial production.

In some embodiments, the filler level was at least 84 weight percent of the total composition. The filler level can be up to 90 weight percent or higher. The formulations generally contained from 0.2% to 4.0% acrylic by weight and the binder level generally ranged from 12% to 20% by weight.

Formulations having from about 0.4% to about 2.5% by weight of acrylic; from about 8% to about 14% by weight of homopolymer; about from 3.5% to about 6% by weight of plasticizer; about 2% of stabilizer based on the PVC used; and from about 84 to about 90% by weight of filler have produced sheets of modified VCT. In some embodiments the product was about 0.8% to about 1.2% by weight of acrylic; about 8% to about 11% by weight of homopolymer; about 4% to about 5% by weight of plasticizer; and about 84% to about 86% by weight of filler.

In general, there was less acrylic used than in typical VCT which included acrylic in the form of PVC/PVAc copolymer. The homopolymer level was generally increased. Plasticizer level was slightly reduced. Stabilizer level was reduced because the overall vinyl level was reduced. The filler level was generally increased.

Polyvinyl butryal (PVB) was also used to replace some of the homopolymer and plasticizer. The PVB used in some of the formulations was post industrial and included a stabilizer which also replaced the mixed metal stabilizer.

The acrylic polymers may be methyl, ethyl, or butyl esters or copolymers thereof. The filler is typically calcium or magnesium carbonate, such as limestone. The stabilizer is typically a mixed metal stabilizer such as a calcium/zinc composition. The plasticizer blend is typically a mixture of phthalate esters and other plasticizers. The pigments can include titanium dioxide, iron oxides, phthalocyanine blue, phthalocyanine green, azo red, benzidene yellow, and carbon black.

Standard VCT processing equipment and conditions can be used to fuse the non- or reduced PVC/PVAc resin. For example, the materials listed above were charged into a steam-jacketed, low shear mixer (Baker-Perkins) and mixed to a temperature of 285° F. to 300° F. The mixed material was placed on a two roll mill and calendered into a continuous web (blanket) about ⅛″ thick.

The materials then may be cut or broken into small chips for further processing, or covered with decorative chips or polymeric wear layers to create a finished floor tile. The mixed materials may be blended with decorative chips before calendaring to create a more decorative effect (jaspe' sheet) before being cut or broken. The chips are then reheated and reconsolidated into a continuous blanket and further calendered to a finished thickness of from 0.020″ to 0.200″. The blanket is heat treated to develop physical properties, cooled, polished, and cut to final dimension before packaging.

The composition can also be used to form the base for a printed tile or used in a sheet floor.

High intensity mixers may be used instead of the low shear mixers. This gives more flexibility in the formulation, allowing the process to run faster and hotter.

The following tables list the formulas used to make the copolymer replacement compositions of the present invention and the results of the evaluation of the compositions.

Formulas for Copolymer Replacement

| | Example No. | | | | | | | | | |
|---|---|---|---|---|---|---|---|---|---|---|
| Component (by wt) | Comparative | 1 | 2 | 3 | 4 | 5 | 6 | 7 | 8 | 9 |
| PVC homopolymer | 84.2 | 84.2 | 124.0 | 108.0 | 108.0 | 108.0 | 115.8 | 108.0 | 115.8 | 115.8 |
| PVC/PVAc copolymer | 52.6 | 44.6 | 0.0 | 0.0 | 0.0 | 0.0 | 0.0 | 0.0 | 0.0 | 0.0 |
| Modified PVC/PVAc copolymer | | | | | | | | | | |
| Hydrocarbon resin | 0.0 | 0.0 | 0.0 | 0.0 | 0.0 | 12.0 | 0.0 | 0.0 | 0.0 | 0.0 |
| Alpha-methyl styrene resin | 0.0 | 0.0 | 0.0 | 0.0 | 12.0 | 0.0 | 0.0 | 0.0 | 0.0 | 0.0 |
| Acrylic process aid | 0.0 | 8.0 | 14.0 | 21.0 | 12.0 | 12.0 | 21.0 | 21.0 | 21.0 | 21.0 |
| Butylbenzyl phthalate/ | 44.2 | 41.5 | 44.2 | 44.2 | 44.2 | 44.2 | 44.2 | 44.2 | 44.2 | 44.2 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 11.0 | 10.4 | 11.0 | 11.0 | 11.0 | 11.0 | 11.0 | 11.0 | 11.0 | 11.0 |
| Limestone | 998.0 | 1001.5 | 997.1 | 1006.4 | 1003.4 | 1003.4 | 998.3 | 1006.4 | 998.5 | 998.5 |
| Titanium dioxide pigment | 7.2 | 7.2 | 7.2 | 7.2 | 7.2 | 7.2 | 7.2 | 7.2 | 7.2 | 7.2 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 2.8 | 2.6 | 2.5 | 2.2 | 2.2 | 2.2 | 2.5 | 2.2 | 2.3 | 2.3 |
| Polyvinyl butryal post industrial | 0.0 | 0.0 | 0.0 | 0.0 | 0.0 | 0.0 | 0.0 | 0.0 | 0.0 | 0.0 |
| Percent Binder | 16.2 | 15.9 | 16.3 | 15.5 | 15.8 | 15.8 | 16.2 | 15.5 | 16.2 | 16.2 |
| Total (by weight) | 1200.0 | 1200.0 | 1200.0 | 1200.0 | 1200.0 | 1200.0 | 1200.0 | 1200.0 | 1200.0 | 1200.0 |

| | Example No. | | | | | | | | | |
|---|---|---|---|---|---|---|---|---|---|---|
| Component (by wt) | 10 | 11 | 12 | 13 | 14 | 15 | 16 | 17 | 18 | 19 |
| PVC homopolymer | 115.8 | 106.0 | 111.0 | 113.2 | 108.2 | 115.8 | 119.8 | 119.8 | 121.0 | 122.0 |
| PVC/PVAc copolymer | 0.0 | 0.0 | 0.0 | 0.0 | 0.0 | 0.0 | 0.0 | 0.0 | 0.0 | 0.0 |
| Modified PVC/PVAc copolymer | | 15.0 | 15.0 | | | | | | | |
| Hydrocarbon resin | 0.0 | 0.0 | 0.0 | 0.0 | 5.0 | 5.0 | 5.0 | 0.0 | 0.0 | 0.0 |
| Alpha-methyl styrene resin | 0.0 | 0.0 | 0.0 | 0.0 | 0.0 | 0.0 | 0.0 | 5.0 | 5.0 | 5.0 |
| Acrylic process aid | 21.0 | 15.0 | 10.0 | 21.0 | 21.0 | 14.0 | 10.0 | 10.0 | 14.0 | 14.0 |
| Butylbenzyl phthalate/ | 44.2 | 44.2 | 44.2 | 40.0 | 40.0 | 40.0 | 40.0 | 40.0 | 40.0 | 40.0 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 11.0 | 11.0 | 11.0 | 10.0 | 10.0 | 10.0 | 10.0 | 10.0 | 10.0 | 10.0 |
| Limestone | 998.5 | 999.5 | 999.5 | 1006.2 | 1006.2 | 1005.6 | 1005.6 | 1005.6 | 1000.4 | 999.4 |
| Titanium dioxide pigment | 7.2 | 7.2 | 7.2 | 7.2 | 7.2 | 7.2 | 7.2 | 7.2 | 7.2 | 7.2 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 2.3 | 2.1 | 2.1 | 2.4 | 2.4 | 2.4 | 2.4 | 2.4 | 2.4 | 2.4 |
| Polyvinyl butryal post industrial | 0.0 | 0.0 | 0.0 | 0.0 | 0.0 | 0.0 | 0.0 | 0.0 | 0.0 | 0.0 |
| Percent Binder | 16.2 | 16.1 | 16.1 | 15.6 | 15.6 | 15.6 | 15.6 | 15.6 | 16.0 | 16.1 |
| Total (by weight) | 1200.0 | 1200.0 | 1200.0 | 1200.0 | 1200.0 | 1200.0 | 1200.0 | 1200.0 | 1200.0 | 1200.0 |
| | Example No. | | | | | | | | | |
| Component (by wt) | 20 | 21 | 22 | 23 | 24 | 25 | 26 | 27 | 28 | 29 |
| PVC homopolymer | 121.0 | 122.0 | 122.0 | 122.0 | 122.0 | 122.0 | 129.0 | 132.0 | 118.0 | 125.0 |
| PVC/PVAc copolymer | 0.0 | 0.0 | 0.0 | 0.0 | 0.0 | 0.0 | 0.0 | 0.0 | 0.0 | 0.0 |
| Modified PVC/PVAc copolymer | | | | | | | | | | |
| Hydrocarbon resin | 0.0 | 5.0 | 5.0 | 5.0 | 0.0 | 5.0 | 5.0 | 5.0 | 5.0 | 5.0 |
| Alpha-methyl styrene resin | 10.0 | 0.0 | 0.0 | 0.0 | 5.0 | 0.0 | 0.0 | 0.0 | 0.0 | 0.0 |
| Acrylic process aid | 10.0 | 14.0 | 14.0 | 14.0 | 14.0 | 14.0 | 7.0 | 4.0 | 14.0 | 7.0 |
| Butylbenzyl phthalate/ | 40.0 | 40.0 | 40.0 | 40.0 | 40.0 | 40.0 | 40.0 | 40.0 | 40.0 | 40.0 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 10.0 | 10.0 | 10.0 | 10.0 | 10.0 | 10.0 | 10.0 | 10.0 | 10.0 | 10.0 |
| Limestone | 999.4 | 999.4 | 999.4 | 999.4 | 999.4 | 999.4 | 999.4 | 999.4 | 1003.4 | 1003.4 |
| Titanium dioxide pigment | 7.2 | 7.2 | 7.2 | 7.2 | 7.2 | 7.2 | 7.2 | 7.2 | 7.2 | 7.2 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 2.4 | 2.4 | 2.4 | 2.4 | 2.4 | 2.4 | 2.4 | 2.4 | 2.4 | 2.4 |
| Polyvinyl butryal post industrial | 0.0 | 0.0 | 0.0 | 0.0 | 0.0 | 0.0 | 0.0 | 0.0 | 0.0 | 0.0 |
| Percent Binder | 16.1 | 16.1 | 16.1 | 16.1 | 16.1 | 16.1 | 16.1 | 16.1 | 15.8 | 15.8 |
| Total (by weight) | 1200.0 | 1200.0 | 1200.0 | 1200.0 | 1200.0 | 1200.0 | 1200.0 | 1200.0 | 1200.0 | 1200.0 |
| | Example No. | | | | | | | | | |
| Component (by wt) | 30 | 31 | 32 | 33 | 34 | 35 | 36 | 37 | 38 | 39 |
| PVC homopolymer | 128.0 | 80.0 | 86.0 | 88.0 | 79.0 | 83.0 | 85.0 | 119.0 | 115.0 | 106.0 |
| PVC/PVAc copolymer | 0.0 | 0.0 | 0.0 | 0.0 | 0.0 | 0.0 | 0.0 | 0.0 | 0.0 | 0.0 |
| Modified PVC/PVAc copolymer | | | | | | | | | | |
| Hydrocarbon resin | 5.0 | 3.3 | 3.3 | 3.3 | 3.3 | 3.3 | 3.3 | 4.0 | 4.0 | 4.0 |
| Alpha-methyl styrene resin | 0.0 | 0.0 | 0.0 | 0.0 | 0.0 | 0.0 | 0.0 | 0.0 | 0.0 | 0.0 |
| Acrylic process aid | 4.0 | 9.3 | 4.7 | 2.7 | 9.3 | 4.7 | 2.7 | 7.0 | 7.0 | 14.0 |
| Butylbenzyl phthalate/ | 40.0 | 26.7 | 26.7 | 26.7 | 26.7 | 26.7 | 26.7 | 36.0 | 35.2 | 32.0 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 10.0 | 6.7 | 6.7 | 6.7 | 6.7 | 6.7 | 6.7 | 9.0 | 8.8 | 8.0 |
| Limestone | 1003.4 | 667.4 | 666.0 | 666.0 | 668.4 | 669.0 | 669.0 | 1015.4 | 1020.5 | 1026.8 |
| Titanium dioxide pigment | 7.2 | 4.8 | 4.8 | 4.8 | 4.8 | 4.8 | 4.8 | 7.2 | 7.2 | 7.2 |
| VCT scrap | 0.0 | 400.0 | 400.0 | 400.0 | 400.0 | 400.0 | 400.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 2.4 | 1.8 | 1.8 | 1.8 | 1.8 | 1.8 | 1.8 | 2.4 | 2.3 | 2.0 |
| Polyvinyl butryal post industrial | 0.0 | 0.0 | 0.0 | 0.0 | 0.0 | 0.0 | 0.0 | 0.0 | 0.0 | 0.0 |
| Percent Binder | 15.8 | 16.6 | 16.2 | 16.2 | 16.2 | 15.8 | 15.8 | 14.8 | 14.4 | 13.8 |
| Total (by weight) | 1200.0 | 1200.0 | 1200.0 | 1200.0 | 1200.0 | 1200.0 | 1200.0 | 1200.0 | 1200.0 | 1200.0 |
| | Example No. | | | | | | | | | |
| Component (by wt) | 40 | 41 | 42 | 43 | 44 | 45 | 46 | 47 | 48 | 49 |
| PVC homopolymer | 100.0 | 42.0 | 79.3 | 76.7 | 70.7 | 66.7 | 28.0 | 121.0 | 121.0 | 128.0 |
| PVC/PVAc copolymer | 0.0 | 0.0 | 0.0 | 0.0 | 0.0 | 0.0 | 0.0 | 0.0 | 0.0 | 0.0 |
| Modified PVC/PVAc copolymer | | | | | | | | | | |
| Hydrocarbon resin | 4.0 | 4.0 | 2.7 | 2.7 | 2.7 | 2.7 | 2.7 | 2.5 | 1.2 | 5.0 |
| Alpha-methyl styrene resin | 0.0 | 0.0 | 0.0 | 0.0 | 0.0 | 0.0 | 0.0 | 0.0 | 0.0 | 0.0 |
| Acrylic process aid | 14.0 | 42.0 | 4.7 | 4.7 | 9.3 | 9.3 | 28.0 | 14.0 | 14.0 | 7.0 |
| Butylbenzyl phthalate/ | 28.8 | 16.0 | 24.0 | 23.5 | 21.3 | 19.2 | 13.3 | 40.0 | 40.0 | 41.6 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 7.2 | 4.0 | 6.0 | 5.9 | 5.3 | 4.8 | 3.3 | 10.0 | 10.0 | 10.4 |
| Limestone | 1036.8 | 1083.8 | 676.9 | 680.2 | 684.5 | 693.1 | 724.1 | 1002.9 | 1004.2 | 998.3 |
| Titanium dioxide pigment | 7.2 | 7.2 | 4.8 | 4.8 | 4.8 | 4.8 | 4.8 | 7.2 | 7.2 | 7.2 |
| VCT scrap | 0.0 | 0.0 | 400.0 | 400.0 | 400.0 | 400.0 | 400.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 2.0 | 1.0 | 1.6 | 1.5 | 1.4 | 1.6 | 0.6 | 2.4 | 2.4 | 2.5 |
| Polyvinyl butryal post industrial | 0.0 | 0.0 | 0.0 | 0.0 | 0.0 | 0.0 | 0.0 | 0.0 | 0.0 | 0.0 |
| Percent Binder | 13.0 | 9.1 | 14.8 | 14.4 | 13.8 | 12.8 | 8.9 | 15.8 | 15.7 | 16.2 |
| Total (by weight) | 1200.0 | 1200.0 | 1200.0 | 1200.0 | 1200.0 | 1200.0 | 1200.0 | 1200.0 | 1200.0 | 1200.0 |
| | Example No. | | | | | | | | | |
| Component (by wt) | 50 | 51 | 52 | 53 | 54 | 55 | 56 | 57 | 58 | 59 |
| PVC homopolymer | 128.0 | 128.0 | 128.0 | 130.0 | 130.0 | 126.0 | 121.0 | 126.0 | 121.0 | 126.0 |
| PVC/PVAc copolymer | 0.0 | 0.0 | 0.0 | 0.0 | 0.0 | 0.0 | 0.0 | 0.0 | 0.0 | 0.0 |
| Modified PVC/PVAc copolymer | | | | | | | | | | |
| Hydrocarbon resin | 3.5 | 2.5 | 1.2 | 3.0 | 0.0 | 0.0 | 5.0 | 0.0 | 5.0 | 0.0 |
| Alpha-methyl styrene resin | 0.0 | 0.0 | 0.0 | 0.0 | 0.0 | 0.0 | 0.0 | 0.0 | 0.0 | 0.0 |
| Acrylic process aid | 7.0 | 7.0 | 7.0 | 6.0 | 9.0 | 14.0 | 14.0 | 14.0 | 14.0 | 14.0 |
| Butylbenzyl phthalate/ | 41.6 | 41.6 | 41.6 | 41.6 | 41.6 | 40.0 | 40.0 | 40.0 | 40.0 | 40.0 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 10.4 | 10.4 | 10.4 | 10.4 | 10.4 | 10.0 | 10.0 | 10.0 | 10.0 | 10.0 |
| Limestone | 999.8 | 1000.8 | 1002.1 | 999.2 | 999.2 | 1000.3 | 1000.4 | 1000.3 | 1000.4 | 1000.3 |
| Titanium dioxide pigment | 7.2 | 7.2 | 7.2 | 7.2 | 7.2 | 7.2 | 7.2 | 7.2 | 7.2 | 7.2 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 2.5 | 2.5 | 2.5 | 2.6 | 2.6 | 2.5 | 2.4 | 2.5 | 2.4 | 2.5 |
| Polyvinyl butryal post industrial | 0.0 | 0.0 | 0.0 | 0.0 | 0.0 | 0.0 | 0.0 | 0.0 | 0.0 | 0.0 |
| Percent Binder | 16.1 | 16.0 | 15.9 | 16.1 | 16.1 | 16.0 | 16.0 | 16.0 | 16.0 | 16.0 |
| Total (by weight) | 1200.0 | 1200.0 | 1200.0 | 1200.0 | 1200.0 | 1200.0 | 1200.0 | 1200.0 | 1200.0 | 1200.0 |
| | Example No. | | | | | | | | | |
| Component (by wt) | 60 | 61 | 62 | 63 | 64 | 65 | 66 | 67 | 68 | 69 |
| PVC homopolymer | 122.0 | 122.0 | 119.0 | 109.0 | 109.0 | 122.0 | 122.0 | 122.0 | 122.0 | 122.0 |
| PVC/PVAc copolymer | 0.0 | 0.0 | 0.0 | 0.0 | 0.0 | 0.0 | 0.0 | 0.0 | 0.0 | 0.0 |
| Modified PVC/PVAc copolymer | | | | | 3.0 | | | | | |
| Hydrocarbon resin | 0.0 | 0.0 | 0.0 | 0.0 | 0.0 | 0.0 | 0.0 | 0.0 | 0.0 | 0.0 |
| Alpha-methyl styrene resin | 0.0 | 0.0 | 0.0 | 0.0 | 0.0 | 0.0 | 0.0 | 0.0 | 0.0 | 0.0 |
| Acrylic process aid | 14.0 | 14.0 | 9.0 | 14.0 | 11.0 | 14.0 | 14.0 | 14.0 | 7.0 | 7.0 |
| Butylbenzyl phthalate/ | 40.0 | 40.0 | 36.0 | 32.8 | 32.8 | 40.0 | 40.0 | 40.0 | 40.0 | 40.0 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 10.0 | 10.0 | 9.0 | 8.2 | 8.2 | 10.0 | 10.0 | 10.0 | 10.0 | 10.0 |
| Limestone | 1004.4 | 1004.4 | 1017.5 | 1026.6 | 1026.6 | 1004.4 | 1004.4 | 1004.4 | 1011.4 | 1011.4 |
| Titanium dioxide pigment | 7.2 | 7.2 | 7.2 | 7.2 | 7.2 | 7.2 | 7.2 | 7.2 | 7.2 | 7.2 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 2.4 | 2.4 | 2.3 | 2.2 | 2.2 | 2.4 | 2.4 | 2.4 | 2.4 | 2.4 |
| Polyvinyl butryal post industrial | 0.0 | 0.0 | 0.0 | 0.0 | 0.0 | 0.0 | 0.0 | 0.0 | 0.0 | 0.0 |
| Percent Binder | 15.7 | 15.7 | 14.6 | 13.9 | 13.9 | 15.7 | 15.7 | 15.7 | 15.1 | 15.1 |
| Total (by weight) | 1200.0 | 1200.0 | 1200.0 | 1200.0 | 1200.0 | 1200.0 | 1200.0 | 1200.0 | 1200.0 | 1200.0 |
| | Example No. | | | | | | | | | |
| Component (by wt) | 70 | 71 | 72 | 73 | 74 | 75 | 76 | 77 | 78 | 79 |
| PVC homopolymer | 122.0 | 87.6 | 122.0 | 119.0 | 109.0 | 82.6 | 122.0 | 119.0 | 109.0 | 82.6 |
| PVC/PVAc copolymer | 0.0 | 0.0 | 0.0 | 0.0 | 0.0 | 0.0 | 0.0 | 0.0 | 0.0 | 0.0 |
| Modified PVC/PVAc copolymer | | | | | | | | | | |
| Hydrocarbon resin | 0.0 | 0.0 | 0.0 | 0.0 | 0.0 | 0.0 | 0.0 | 0.0 | 0.0 | 0.0 |
| Alpha-methyl styrene resin | 0.0 | 0.0 | 0.0 | 0.0 | 0.0 | 0.0 | 0.0 | 0.0 | 0.0 | 0.0 |
| Acrylic process aid | 7.0 | 21.0 | 14.0 | 9.0 | 9.0 | 21.0 | 14.0 | 9.0 | 9.0 | 21.0 |
| Butylbenzyl phthalate/ | 40.0 | 31.8 | 40.0 | 36.0 | 44.0 | 36.0 | 40.0 | 40.0 | 44.0 | 36.0 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 10.0 | 8.0 | 10.0 | 9.0 | 11.0 | 9.0 | 10.0 | 10.0 | 11.0 | 9.0 |
| Limestone | 1011.4 | 1042.7 | 1004.4 | 1017.5 | 1017.7 | 1042.6 | 1004.4 | 1012.5 | 1017.7 | 1042.6 |
| Titanium dioxide pigment | 7.2 | 7.2 | 7.2 | 7.2 | 7.2 | 7.2 | 7.2 | 7.2 | 7.2 | 7.2 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 2.4 | 1.7 | 2.4 | 2.3 | 2.1 | 1.6 | 2.4 | 2.3 | 2.1 | 1.6 |
| Polyvinyl butryal post industrial | 0.0 | 0.0 | 0.0 | 0.0 | 0.0 | 0.0 | 0.0 | 0.0 | 0.0 | 0.0 |
| Percent Binder | 15.1 | 12.5 | 15.7 | 14.6 | 14.6 | 12.5 | 15.7 | 15.0 | 14.6 | 12.5 |
| Total (by weight) | 1200.0 | 1200.0 | 1200.0 | 1200.0 | 1200.0 | 1200.0 | 1200.0 | 1200.0 | 1200.0 | 1200.0 |
| | Example No. | | | | | | | | | |
| Component (by wt) | 80 | 81 | 82 | 83 | 84 | 85 | 86 | 87 | 88 | 89 |
| PVC homopolymer | 110.0 | 100.8 | 84.0 | 122.0 | 110.0 | 100.8 | 84.0 | 104.8 | 104.8 | 104.8 |
| PVC/PVAc copolymer | 0.0 | 0.0 | 0.0 | 0.0 | 0.0 | 0.0 | 0.0 | 0.0 | 0.0 | 0.0 |
| Modified PVC/PVAc copolymer | | | | | | | | | | |
| Hydrocarbon resin | 0.0 | 0.0 | 0.0 | 0.0 | 0.0 | 0.0 | 0.0 | 0.0 | 0.0 | 0.0 |
| Alpha-methyl styrene resin | 0.0 | 0.0 | 0.0 | 0.0 | 0.0 | 0.0 | 0.0 | 0.0 | 0.0 | 0.0 |
| Acrylic process aid | 10.4 | 14.0 | 21.0 | 14.0 | 10.2 | 14.0 | 21.0 | 8.0 | 8.0 | 5.5 |
| Butylbenzyl phthalate/ | 44.0 | 40.0 | 36.0 | 40.0 | 44.0 | 40.0 | 36.0 | 33.4 | 33.4 | 33.4 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 11.0 | 10.0 | 9.0 | 10.0 | 11.0 | 10.0 | 9.0 | 8.3 | 8.3 | 8.3 |
| Limestone | 1015.3 | 1026.0 | 1041.1 | 1004.4 | 1015.5 | 1026.0 | 1041.1 | 837.5 | 837.5 | 834.5 |
| Titanium dioxide pigment | 7.2 | 7.2 | 7.2 | 7.2 | 7.2 | 7.2 | 7.2 | 6.0 | 6.0 | 6.0 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 5.5 |
| impact modifier | | | | | | | | | | |
| Mixed metal stabilizer | 2.1 | 2.0 | 1.7 | 2.4 | 2.1 | 2.0 | 1.7 | 2.0 | 2.0 | 2.0 |
| Polyvinyl butryal post industrial | 0.0 | 0.0 | 0.0 | 0.0 | 0.0 | 0.0 | 0.0 | 0.0 | 0.0 | 0.0 |
| Percent Binder | 14.8 | 13.9 | 12.6 | 15.7 | 14.8 | 13.9 | 12.6 | 15.7 | 15.7 | 16.0 |
| Total (by weight) | 1200.0 | 1200.0 | 1200.0 | 1200.0 | 1200.0 | 1200.0 | 1200.0 | 1000.0 | 1000.0 | 1000.0 |
| | Example No. | | | | | | | | | |
| Component (by wt) | 90 | 91 | 92 | 93 | 94 | 95 | 96 | 97 | 98 | 99 |
| PVC homopolymer | 99.8 | 99.8 | 99.8 | 74.0 | 89.8 | 83.8 | 86.0 | 86.0 | 86.0 | 90.0 |
| PVC/PVAc copolymer | 0.0 | 0.0 | 0.0 | 5.0 | 0.0 | 0.0 | 0.0 | 0.0 | 0.0 | 0.0 |
| Modified PVC/PVAc copolymer | | | | | | | | | | |
| Hydrocarbon resin | 0.0 | 0.0 | 0.0 | 0.0 | 0.0 | 0.0 | 0.0 | 0.0 | 0.0 | 0.0 |
| Alpha-methyl styrene resin | 0.0 | 0.0 | 0.0 | 0.0 | 0.0 | 0.0 | 0.0 | 0.0 | 0.0 | 0.0 |
| Acrylic process aid | 4.0 | 4.0 | 4.0 | 4.0 | 4.0 | 6.0 | 8.0 | 8.0 | 8.0 | 9.5 |
| Butylbenzyl phthalate/ | 36.6 | 36.6 | 36.6 | 34.0 | 35.2 | 34.4 | 34.4 | 34.4 | 34.4 | 35.2 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 9.1 | 9.1 | 9.1 | 8.0 | 8.8 | 8.6 | 8.6 | 8.6 | 8.6 | 8.8 |
| Limestone | 835.5 | 835.5 | 835.5 | 867.3 | 847.4 | 852.4 | 855.3 | 855.3 | 855.3 | 848.7 |
| Titanium dioxide pigment | 6.0 | 6.0 | 6.0 | 6.0 | 6.0 | 6.0 | 6.0 | 6.0 | 6.0 | 6.0 |
| VCT scrap | 0.0 | 0.0 | 0.0 | 0.0 | 0.0 | 0.0 | 0.0 | 0.0 | 0.0 | 0.0 |
| Methacrylate/butadiene | 7.0 | 7.0 | 7.0 | 0.0 | 7.0 | 7.0 | 0.0 | 0.0 | 0.0 | 0.0 |
| impact modifier | | | | | | | | | | |
| Mixed metal stabilizer | 2.0 | 2.0 | 2.0 | 1.7 | 1.8 | 1.8 | 1.7 | 1.7 | 1.7 | 1.8 |
| Polyvinyl butryal post industrial | 0.0 | 0.0 | 0.0 | 0.0 | 0.0 | 0.0 | 0.0 | 0.0 | 0.0 | 0.0 |
| Percent Binder | 15.9 | 15.9 | 15.9 | 12.7 | 14.7 | 14.2 | 13.9 | 13.9 | 13.9 | 14.5 |
| Total (by weight) | 1000.0 | 1000.0 | 1000.0 | 1000.0 | 1000.0 | 1000.0 | 1000.0 | 1000.0 | 1000.0 | 1000.0 |
| | Example No. | | | | | | | | | |
| Component (by wt) | 100 | 101 | 102 | 103 | 104 | 105 | 106 | 107 | 108 | 109 |
| PVC homopolymer | 90.0 | 90.0 | 90.0 | 90.0 | 85.0 | 85.0 | 83.0 | 80.0 | 90.0 | 90.0 |
| PVC/PVAc copolymer | 0.0 | 0.0 | 0.0 | 0.0 | 0.0 | 0.0 | 0.0 | 0.0 | 6.0 | 6.0 |
| Modified PVC/PVAc copolymer | | | | | | | | | | |
| Hydrocarbon resin | 0.0 | 0.0 | 0.0 | 0.0 | 0.0 | 0.0 | 0.0 | 8.0 | 0.0 | 0.0 |
| Alpha-methyl styrene resin | 0.0 | 0.0 | 0.0 | | | | | | | |
| Acrylic process aid | 9.5 | 9.5 | 9.5 | 9.5 | 9.5 | 8.0 | 10.0 | 6.0 | 6.0 | 6.0 |
| Butylbenzyl phthalate/ | 33.6 | 33.6 | 33.6 | 33.6 | 34.4 | 34.4 | 34.4 | 33.6 | 33.6 | 33.6 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 8.4 | 8.4 | 8.4 | 8.4 | 8.6 | 8.6 | 8.6 | 8.4 | 8.4 | 8.4 |
| Limestone | 850.7 | 850.7 | 850.7 | 850.7 | 854.8 | 856.3 | 856.4 | 856.4 | 848.2 | 848.2 |
| Titanium dioxide pigment | 6.0 | 6.0 | 6.0 | 6.0 | 6.0 | 6.0 | 6.0 | 6.0 | 6.0 | 6.0 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 1.8 | 1.8 | 1.8 | 1.8 | 1.7 | 1.7 | 1.6 | 1.6 | 1.8 | 1.8 |
| Polyvinyl butryal post industrial | 0.0 | 0.0 | 0.0 | 0.0 | 0.0 | 0.0 | 0.0 | 0.0 | 0.0 | 0.0 |
| Percent Binder | 14.3 | 14.3 | 14.3 | 14.3 | 13.9 | 13.8 | 13.8 | 13.8 | 14.6 | 14.6 |
| Total (by weight) | 1000.0 | 1000.0 | 1000.0 | 1000.0 | 1000.0 | 1000.0 | 1000.0 | 1000.0 | 1000.0 | 1000.0 |
| | Example No. | | | | | | | | | |
| Component (by wt) | 110 | 111 | 112 | 113 | 114 | 115 | 116 | 117 | 118 | 119 |
| PVC homopolymer | 87.0 | 86.5 | 87.5 | 87.5 | 87.5 | 99.8 | 66.0 | 57.0 | 91.0 | 90.0 |
| PVC/PVAc copolymer | 6.0 | 0.0 | 0.0 | 0.0 | 0.0 | 0.0 | 0.0 | 0.0 | 10.0 | 10.0 |
| Modified PVC/PVAc copolymer | | | | | | | | | | |
| Hydrocarbon resin | 0.0 | 0.0 | 0.0 | 0.0 | 0.0 | 0.0 | 0.0 | 0.0 | 0.0 | 0.0 |
| Alpha-methyl styrene resin | | | 0.0 | 0.0 | 0.0 | 0.0 | 0.0 | 0.0 | | |
| Acrylic process aid | 8.0 | 8.0 | 8.0 | 8.0 | 8.0 | 4.0 | 5.0 | 5.0 | 4.0 | 2.0 |
| Butylbenzyl phthalate/ | 36.0 | 35.2 | 35.2 | 35.2 | 35.2 | 36.0 | 26.7 | 24.0 | 36.0 | 33.6 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 9.0 | 8.8 | 8.8 | 8.8 | 8.8 | 9.0 | 0.0 | 0.0 | 9.0 | 8.4 |
| Limestone | 846.3 | 853.8 | 852.8 | 852.8 | 852.8 | 836.2 | 867.3 | 873.0 | 842.2 | 848.2 |
| Titanium dioxide pigment | 6.0 | 6.0 | 6.0 | 6.0 | 6.0 | 6.0 | 0.0 | 6.0 | 6.0 | 6.0 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 7.0 | 0.0 | 0.0 | 0.0 | 0.0 |
| impact modifier | | | | | | | | | | |
| Mixed metal stabilizer | 1.7 | 1.7 | 1.7 | 1.7 | 1.7 | 2.0 | 0.0 | 0.0 | 1.8 | 1.8 |
| Polyvinyl butryal post industrial | 0.0 | 0.0 | 0.0 | 0.0 | 0.0 | 0.0 | 35.0 | 35.0 | 0.0 | 0.0 |
| Percent Binder | 14.8 | 14.0 | 14.1 | 14.1 | 14.1 | 15.8 | 13.3 | 12.1 | 15.2 | 14.6 |
| Total (by weight) | 1000.0 | 1000.0 | 1000.0 | 1000.0 | 1000.0 | 1000.0 | 1000.0 | 1000.0 | 1000.0 | 1000.0 |
| | Example No. | | | | | | | | | |
| Component (by wt) | 120 | 121 | 122 | 123 | 124 | 125 | 126 | 127 | 128 | 129 |
| PVC homopolymer | 89.0 | 97.0 | 92.0 | 96.0 | 96.0 | 94.0 | 94.0 | 94.0 | 108.0 | 100.0 |
| PVC/PVAc copolymer | 0.0 | 5.0 | 10.0 | 10.0 | 10.0 | 8.0 | 8.0 | 8.0 | 0.0 | 6.0 |
| Modified PVC/PVAc copolymer | | | | | | | | | | |
| Hydrocarbon resin | 0.0 | 0.0 | 0.0 | 0.0 | 0.0 | 0.0 | 0.0 | 0.0 | 0.0 | 0.0 |
| Alpha-methyl styrene resin | | | | | | | | | | |
| Acrylic process aid | 11.6 | 5.0 | 2.0 | 2.0 | 2.0 | 4.0 | 4.0 | 4.0 | 6.0 | 2.0 |
| Butylbenzyl phthalate/ | 34.1 | 36.0 | 32.0 | 36.0 | 36.0 | 36.0 | 36.0 | 36.0 | 36.0 | 36.0 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 8.5 | 9.0 | 8.0 | 9.0 | 9.0 | 9.0 | 9.0 | 9.0 | 9.0 | 9.0 |
| Limestone | 849.0 | 840.1 | 848.2 | 839.1 | 839.1 | 841.1 | 841.1 | 841.1 | 833.0 | 839.0 |
| Titanium dioxide pigment | 6.0 | 6.0 | 6.0 | 6.0 | 6.0 | 6.0 | 6.0 | 6.0 | 6.0 | 6.0 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 1.8 | 1.9 | 1.8 | 1.9 | 1.9 | 1.9 | 1.9 | 1.9 | 2.0 | 2.0 |
| Polyvinyl butryal post industrial | 0.0 | 0.0 | 0.0 | 0.0 | 0.0 | 0.0 | 0.0 | 0.0 | 0.0 | 0.0 |
| Percent Binder | 14.5 | 15.4 | 14.6 | 15.5 | 15.5 | 15.3 | 15.3 | 15.3 | 16.1 | 15.5 |
| Total (by weight) | 1000.0 | 1000.0 | 1000.0 | 1000.0 | 1000.0 | 1000.0 | 1000.0 | 1000.0 | 1000.0 | 1000.0 |
| | Example No. | | | | | | | | | |
| Component (by wt) | 130 | 131 | 132 | 133 | 134 | 135 | 136 | 137 | 138 | 139 |
| PVC homopolymer | 100.0 | 100.0 | 100.0 | 100.0 | 91.0 | 94.0 | 104.8 | 108.6 | 90.0 | 100.6 |
| PVC/PVAc copolymer | 6.0 | 6.0 | 6.0 | 6.0 | 0.0 | 8.0 | 0.0 | 0.0 | 0.0 | 0.0 |
| Modified PVC/PVAc copolymer | | | | | | | | | | |
| Hydrocarbon resin | 0.0 | 0.0 | 0.0 | 0.0 | 0.0 | 0.0 | 0.0 | 0.0 | 0.0 | 0.0 |
| Alpha-methyl styrene resin | | | | | | | 0.0 | 0.0 | 0.0 | 0.0 |
| Acrylic process aid | 2.0 | 2.0 | 2.0 | 2.0 | 11.6 | 4.0 | 11.6 | 5.8 | 11.6 | 5.8 |
| Butylbenzyl phthalate/ | 36.0 | 36.0 | 36.0 | 36.0 | 36.0 | 36.0 | 41.7 | 43.5 | 35.8 | 40.2 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 9.0 | 9.0 | 9.0 | 9.0 | 9.0 | 9.0 | 0.0 | 0.0 | 0.0 | 0.0 |
| Limestone | 839.0 | 839.0 | 839.0 | 839.0 | 844.6 | 841.1 | 839.9 | 839.9 | 860.8 | 851.4 |
| Titanium dioxide pigment | 6.0 | 6.0 | 6.0 | 6.0 | 6.0 | 6.0 | 0.0 | 0.0 | 0.0 | 0.0 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 2.0 | 2.0 | 2.0 | 2.0 | 1.8 | 1.9 | 2.0 | 2.2 | 1.8 | 2.0 |
| Polyvinyl butryal post industrial | 0.0 | 0.0 | 0.0 | 0.0 | 0.0 | 0.0 | 0.0 | 0.0 | 0.0 | 0.0 |
| Percent Binder | 15.5 | 15.5 | 15.5 | 15.5 | 14.9 | 15.3 | 16.0 | 16.0 | 13.9 | 14.9 |
| Total (by weight) | 1000.0 | 1000.0 | 1000.0 | 1000.0 | 1000.0 | 1000.0 | 1000.0 | 1000.0 | 1000.0 | 1000.0 |
| | Example No. | | | | | | | | | |
| Component (by wt) | 140 | 141 | 142 | 143 | 144 | 145 | 146 | 147 | 148 | 149 |
| PVC homopolymer | 95.0 | 86.0 | 96.6 | 90.0 | 89.7 | 68.0 | 84.0 | 91.7 | 70.0 | 91.0 |
| PVC/PVAc copolymer | 0.0 | 0.0 | 0.0 | 0.0 | 0.0 | 0.0 | 0.0 | 0.0 | 0.0 | 0.0 |
| Modified PVC/PVAc copolymer | | | | | | | | | | |
| Hydrocarbon resin | 0.0 | 0.0 | 0.0 | 0.0 | 0.0 | 0.0 | 0.0 | 0.0 | 0.0 | 0.0 |
| Alpha-methyl styrene resin | 0.0 | 0.0 | 0.0 | 0.0 | 0.0 | 0.0 | 0.0 | 0.0 | 0.0 | 0.0 |
| Acrylic process aid | 5.8 | 11.6 | 5.8 | 5.8 | 8.7 | 17.5 | 11.6 | 8.7 | 17.5 | 11.6 |
| Butylbenzyl phthalate/ | 38.0 | 39.8 | 44.2 | 43.0 | 47.8 | 38.1 | 41.8 | 45.8 | 36.1 | 36.0 |
| epoxized soy oil plasticizer | | | | | | | | | | |
| Dibutyl phthalate plasticizer | 0.0 | 0.0 | 0.0 | 0.0 | 0.0 | 0.0 | 0.0 | 0.0 | 0.0 | 0.0 |
| Diisononyl phthalate plasticizer | 0.0 | 0.0 | 0.0 | 0.0 | 0.0 | 0.0 | 0.0 | 0.0 | 0.0 | 9.0 |
| Limestone | 859.3 | 860.9 | 851.5 | 859.4 | 846.0 | 869.0 | 855.0 | 846.0 | 869.0 | 844.6 |
| Titanium dioxide pigment | 0.0 | 0.0 | 0.0 | 0.0 | 6.0 | 6.0 | 6.0 | 6.0 | 6.0 | 6.0 |
| VCT scrap | 0.0 | 0.0 | 0.0 | 0.0 | 0.0 | 0.0 | 0.0 | 0.0 | 0.0 | 0.0 |
| Methacrylate/butadiene | 0.0 | 0.0 | 0.0 | 0.0 | 0.0 | 0.0 | 0.0 | 0.0 | 0.0 | 0.0 |
| impact modifier | | | | | | | | | | |
| Mixed metal stabilizer | 1.9 | 1.7 | 1.9 | 1.8 | 1.8 | 1.4 | 1.6 | 1.8 | 1.4 | 1.8 |
| Polyvinyl butryal post industrial | 0.0 | 0.0 | 0.0 | 0.0 | 0.0 | 0.0 | 0.0 | 0.0 | 0.0 | 0.0 |
| Percent Binder | 14.1 | 13.9 | 14.9 | 14.1 | 14.8 | 12.5 | 13.9 | 14.8 | 12.5 | 14.9 |
| Total (by weight) | 1000.0 | 1000.0 | 1000.0 | 1000.0 | 1000.0 | 1000.0 | 1000.0 | 1000.0 | 1000.0 | 1000.0 |

Example No.

| Component (by wt) | 150 | 151 | 152 | 153 |
|---|---|---|---|---|
| PVC homopolymer | 81.0 | 66.1 | 89.0 | 75.0 |
| PVC/PVAc copolymer | 0.0 | 0.0 | 0.0 | 0.0 |
| Modified PVC/PVAc copolymer | | | | |
| Hydrocarbon resin | 0.0 | 0.0 | 0.0 | 0.0 |
| Alpha-methyl styrene resin | 0.0 | 0.0 | 0.0 | 0.0 |
| Acrylic process aid | 15.6 | 22.5 | 11.6 | 20.0 |
| Butylbenzyl phthalate/ | 32.6 | 28.1 | 34.1 | 30.9 |
| epoxized soy oil plasticizer | | | | |
| Dibutyl phthalate plasticizer | 0.0 | 0.0 | 0.0 | 0.0 |
| Diisononyl phthalate plasticizer | 8.2 | 7.0 | 8.5 | 7.7 |
| Limestone | 855.0 | 869.0 | 849.0 | 859.0 |
| Titanium dioxide pigment | 6.0 | 6.0 | 6.0 | 6.0 |
| VCT scrap | 0.0 | 0.0 | 0.0 | 0.0 |
| Methacrylate/butadiene | 0.0 | 0.0 | 0.0 | 0.0 |
| impact modifier | | | | |
| Mixed metal stabilizer | 1.6 | 1.3 | 1.8 | 1.4 |
| Polyvinyl butryal post industrial | 0.0 | 0.0 | 0.0 | 0.0 |
| Percent Binder | 13.9 | 12.5 | 14.5 | 13.5 |
| Total (by weight) | 1000.0 | 1000.0 | 1000.0 | 1000.0 |

Batch Notes for Copolymer Replacement Evaluation

| Example No. | Comments |
|---|---|
| Comparative | All vinyl control; 10 min mix time; good, lumpy mix @ 285° F.; good |
| | blanket, good roll tack, good hot strength, self feeding, FR 215° F. |
| 1 | 10 min mix time; good, lumpy mix @ 283° F.; good blanket, good roll tack, |
| | good hot strength, self feeding, FR 215° F. |
| 2 | 20 min mix time; slightly lumpy mix @ 300° F.; good blanket; good roll tack; |
| | good hot strength; not self feeding; FR 250° F. |
| 3 | 18 min mix time; good, lumpy mix @ 287° F.; very good roll tack; good |
| | blanket; good hot strength; self feeding; FR 242° F. |
| 4 | 10 min mix time; good, lumpy mix @ 283° F.; good roll tack; good blanket; |
| | good hot strength; not self feeding; FR 233° F. |
| 5 | 10 min mix time; slightly dry mix @ 281° F.; good roll tack; good blanket; |
| | good hot strength; self feeding; FR 235° F. |
| 6 | 15 min mix time; slightly lumpy mix @ 304° F.; fair roll tack; poor blanket; |
| | no hot strength; not self feeding; FR 230° F. |
| 7 | 15 min mix time; sandy mix with some lumps; good mill feed; good roll |
| | tack; excellent hot strength; FR 235° F. |
| 8 | 5.5 min mix; lumpy mix; good roll tack; good blanket; fair hot strength; |
| | FR 235° F. |
| 9 | 9.5 min mix; lumpy mix; poor initial feed, but improved; mix went to back |
| | roll initially, but came to front roll with repeated milling; good blanket; |
| | good hot strength; FR 235° F. |
| 10 | 12.5 min mix; lumpy mix; good feed, but poor initial roll tack; tack |
| | improved on second pass on mill; good blanket; good hot strength; FR |
| | 235° F. |
| 11 | 7.5 min mix; lumpy mix; fair mill feed; good roll tack; good blanket; good |
| | hot strength; FR 235° F. |
| 12 | 7.5 min mix; lumpy mix; fair mill feed; fair to good roll tack; poor blanket; |
| | poor hot strength; fell apart after calendaring; FR 235° F. |
| 13 | 17 min mix; good, lumpy batch; good mill feed; poor roll tack that got |
| | better with repeated passes through the mill; good blanket; good hot |
| | strength; FR 225° F. |
| 14 | 10 min mix; good, lumpy batch; good mill feed; excellent roll tack; good |
| | blanket; good hot strength; FR 240° F. |
| 15 | 10 min mix; good, lumpy batch; good mill feed; excellent roll tack; good |
| | blanket; good hot strength; FR 240° F. |
| 16 | 10 min mix; good, lumpy batch; fair mill feed; fair roll tack; good blanket; |
| | fair hot strength; FR 240° F. |
| 17 | 10 min mix; good, lumpy batch; good mill feed; good roll tack; good |
| | blanket; good hot strength; FR 240° F. |
| 18 | 19 min mix; lumpy mix; MT 293° F.; good mill feed; fair roll tack; fair |
| | blanket; good hot strength; FR 240° F. |
| 19 | 20 min mix; dry, powdery mix; MT 293° F.; fed well with closed mill nip; |
| | opened nip; excellent roll tack; excellent blanket; excellent hot strength; |
| | FR 240° F. |
| 20 | 20 min mix; dry, powdery mix; closed mill nip; batch fused on mill; opened |
| | nip; excellent roll tack, blanket, hot strength; FR 240° F. |
| 21 | 9.5 min mix; nice, lumpy batch; MT 287° F.; excellent mill feed and roll |
| | tack; excellent blanket and hot strength; FR 240° F. |
| 22 | 9 min mix; nice, lumpy batch; MT 286° F.; excellent mill feed and roll tack; |
| | excellent blanket and hot strength; FR 240° F. |
| 23 | 15.5 min mix; dry, powdery mix; MT 289° F.; closed mill nip; batch fused on |
| | mill; excellent tack; excellent blanket and hot strength; FR240° F. |
| 24 | 9.5 min mix; nice, lumpy batch; MT 291° F.; excellent mill feed and roll |
| | tack; excellent blanket and hot strength; FR 240° F. |
| 25 | 15 min mix; very dry, powdery mix; MT 290° F.; closed mill nip; batch fused |
| | on mill; opened nip; good roll tack; excellent blanket and hot strength; FR |
| | 240° F. |
| 26 | 9.5 min mix; good, lumpy mix; MT 284° F.; good mill feed; excellent roll |
| | tack; very good blanket; good hot strength; FR 240° F. |
| 27 | 9.5 min mix; good, lumpy mix; slightly drier than Example 18; MT 289° F.; |
| | good mill feed and roll tack; good blanket; poor hot strength; FR 240° F. |
| 28 | 9.5 min mix; good, lumpy mix; MT 290° F.; good mill feed; excellent roll |
| | tack; good blanket; fair hot strength; FR 240° F. |
| 29 | 9.5 min mix; good, lumpy mix; MT 291° F.; good mill feed; very good roll |
| | tack; fair blanket; poor hot strength; FR 240° F. |
| 30 | 10 min mix; good, lumpy mix; MT 289° F.; good mill feed; very good roll |
| | tack; poor blanket and hot strength; FR 240° F. |
| 31 | 8 min mix; good, lumpy mix; MT 282° F.; excellent mill feed and roll tack; |
| | excellent blanket and hot strength; FR 240° F. |
| 32 | 7 min mix; good, lumpy mix; MT 281° F.; excellent mill feed and roll tack; |
| | very good blanket; good hot strength; FR 240° F. |
| 33 | 9 min mix; good, lumpy mix; MT 287° F.; excellent mill feed and roll tack; |
| | very good blanket; good hot strength; FR 240° F. |
| 34 | 9.5 min mix; good, lumpy mix; MT 286° F.; excellent mill feed and roll tack; |
| | excellent blanket and hot strength; FR 240° F. |
| 35 | 9.5 min mix; good, lumpy mix; MT 289° F.; excellent mill feed and roll tack; |
| | excellent blanket; very good hot strength; FR 240° F. |
| 36 | dry, powdery mix; MT 292° F.; closed mill nip; mix fused on mill; poor roll |
| | tack; very brittle blanket with fair hot strength; FR 240° F. |
| 37 | 9 min mix; good, lumpy batch; MT 286° F.; excellent mill feed; very good |
| | roll tack; very good blanket and hot strength; FR 240° F. |
| 38 | 8.5 min mix; good, lumpy batch; excellent mill feed; very good roll tack; |
| | good blanket and hot strength; FR 240° F. |
| 39 | 11 min mix; good, lumpy batch; MT 287° F.; very good mill feed and roll |
| | tack; very good blanket and hot strength; FR 240° F. |
| 40 | 15 min mix; lumpy batch but slightly dry; very good mill feed and roll |
| | tack; very good blanket; fair hot strength; FR 240° F. |
| 41 | 20 min mix; dry, powdery mix; MT 291° F.; closed mill nip; mix fused on |
| | mill; fair roll tack; brittle blanket with poor hot strength; FR 240° F. |
| 42 | 12 min mix; good, lumpy mix; MT 292° F.; excellent mill feed and roll tack; |
| | very good blanket; fair hot strength; FR 240° F. |
| 43 | 18 min mix; good, lumpy batch; MT 295° F.; excellent mill feed and roll |
| | tack; excellent blanket and hot strength; FR 240° F. |
| 44 | 8 min mix; good, lumpy mix; MT 287° F.; excellent mill feed and roll tack; |
| | excellent blanket and hot strength; FR 240° F. |
| 45 | 8 min mix; good, lumpy mix; MT 286° F.; excellent mill feed and roll tack; |
| | very good blanket and hot strength; FR 240° F. |
| 46 | 9 min mix; good, lumpy mix; MT 287° F.; excellent mill feed and roll tack; |
| | fair blanket and hot strength; FR 240° F. |
| 47 | 13 min mix; good, lumpy mix; MT 290° F.; excellent mill feed and roll tack; |
| | fair blanket and hot strength; FR 240° F. |
| 48 | 25 min mix; very dry, powdery mix; closed mill nip; mix fused on mill; very |
| | brittle blanket; no hot strength |
| 49 | 25 min mix; very dry, powdery mix; closed mill nip; mix fused on mill; very |
| | brittle blanket; no hot strength |
| 50 | 20 min mix; dry, powdery mix; MT 291 F; closed mill nip; mix fused on |
| | mill; excellent mill feed and roll tack; excellent blanket and hot strength; |
| | FR 240° F. |
| 51 | 7.5 min mix; good, lumpy mix; MT 289° F.; excellent mill feed and roll tack; |
| | excellent blanket and hot strength; FR 240° F. |
| 52 | 15 min mix; dry, powdery mix; MT 286° F.; closed mill nip; mix fused on |
| | mill; excellent mill feed and roll tack; excellent blanket; very good hot |
| | strength; FR 240° F. |
| 53 | 20 min mix; dry, powdery mix; MT 286° F.; closed mill nip; mix fused on |
| | mill; excellent mill feed and roll tack; excellent blanket and hot strength; |
| | FR 240° F. |
| 54 | 20 min mix; dry, powdery mix; MT 284° F.; closed mill nip; mix fused on |
| | mill; excellent mill feed and roll tack; excellent blanket and hot strength; |
| | FR 240° F. |
| 55 | 15 min mix; dry, powdery mix; MT 287° F.; closed mill nip; mix fused on |
| | mill; excellent mill feed and roll tack; excellent blanket and hot strength; |
| | FR 240° F. |
| 56 | 15 min mix; very dry mix; MT 286° F.; fused on mill; excellent mill feed; |
| | excellent roll tack; excellent blanket and hot strength; FR 40 psi |
| 57 | 20 min mix; very dry mix; MT 287° F.; fused on mill; excellent mill feed, roll |
| | tack, blanket; very good hot strength; FR 260° F. |
| 58 | 20 min mix; very dry mix; MT 284° F.; fused on mill; excellent mill feed, roll |
| | tack; fair blanket, very brittle; poor hot strength; FR 260° F. |
| 59 | 20 min mix; very dry mix; MT 302° F.; fused on mill; excellent mill feed; |
| | very good roll tack; good blanket and hot strength; FR 258° F. |
| 60 | 15 min mix; very dry mix; MT 284° F.; fused on mill; excellent mill feed, roll |
| | tack, blanket, hot strength; strong odor; FR 36 psi |
| 61 | 15 min mix; very dry mix; MT 284° F.; fused on mill; excellent mill feed, roll |
| | tack, blanket, hot strength; FR 36 psi |
| 62 | 15 min mix; very dry mix; MT 286° F.; fused on mill; excellent mill feed, roll |
| | tack, blanket, hot strength; FR 36 psi |
| 63 | 12 min mix; very dry mix; MT 285° F.; fused on mill; excellent mill feed; |
| | good roll tack, blanket, hot strength; FR 36 psi |
| 64 | 15 min mix; very dry mix; MT 287° F.; fused on mill; excellent mill feed, roll |
| | tack; good blanket, hot strength; FR 36 psi |
| 65 | 14 min mix; very dry mix; MT 286° F.; fused on mill; excellent mill feed, roll |
| | tack; good blanket; fair hot strength; FR 36 psi |
| 66 | 15 min mix; very dry mix; MT 288° F.; fused on mill; excellent mill feed, roll |
| | tack, blanket, hot strength; FR 245° F. |
| 67 | 15 min mix; very dry mix; MT 287° F.; fused on mill; excellent mill feed, roll |
| | tack, blanket, hot strength; FR 242° F. |
| 68 | 15 min mix; very dry mix; MT 284° F.; fused on mill; excellent mill feed; |
| | very good roll tack; good hot strength; very brittle blanket; |
| 69 | 15 min mix; very dry mix; MT 288° F.; fused on mill; excellent mill feed; |
| | very good roll tack; good hot strength; very brittle blanket; FR 242 F |
| 70 | 15 min mix; very dry mix; MT 287° F.; fused on mill; very good mill feed |
| | and roll tack; good hot strength; very brittle blanket; FR 246° F. |
| 71 | 15 min mix; very dry mix; MT 286° F.; fused on mill; excellent mill feed, roll |
| | tack, hot strength; slightly brittle blanket; FR 246° F. |
| 72 | 15 min mix; very dry mix; MT 286° F.; fused on mill; excellent mill feed, roll |
| | tack, blanket, hot strength; FR 246° F. |
| 73 | 15 min mix; very dry mix; MT 287° F.; fused on mill; excellent mill feed, roll |
| | tack; good hot strength; very good blanket; FR 246° F. |
| 74 | 15 min mix; very dry mix; MT 288° F.; fused on mill; excellent mill feed, roll |
| | tack; very good hot strength, blanket; FR 246° F. |
| 75 | 15 min mix; very dry mix; MT 293° F.; fused on mill; poor mill feed, added |
| | alpha-methyl styrene resin; blanket went to back roll(300° F.); excellent |
| | blanket, hot strength; FR 246° F. |
| 76 | 12 min mix; nice lumpy batch; MT 285° F.; poor mill feed; blanket went to |
| | back roll(300° F.); fair roll tack to back roll; very good blanket, but very soft |
| | and flexible; FR 275° F. |
| 77 | 15 min mix; very dry mix; MT 280° F.; fused on mill; excellent mill feed, roll |
| | tack, blanket, hot strength; FR 240° F. |
| 78 | 15 min mix; very dry mix; MT 287° F.; fused on mill; excellent mill feed, roll |
| | tack, blanket, hot strength; FR 240° F. |
| 79 | 15 min mix; very dry batch; MT 284° F.; fused on mill; excellent mill feed, |
| | roll tack, blanket, hot strength; FR 240° F. |
| 80 | 15 min mix; very dry mix; MT 281° F.; fused on mill; excellent mill feed, roll |
| | tack; very good blanket, hot strength; FR 250° F. |
| 81 | 15 min mix; very dry mix; MT 281° F.; fused on mill; excellent mill feed, roll |
| | tack; fair blanket; good hot strength; FR 250° F. |
| 82 | 15 min mix; very dry mix; MT 287° F.; fused on mill; excellent mill feed, roll |
| | tack, hot strength; very good blanket; FR 28 psi |
| 83 | 15 min mix; very dry mix; MT 286° F.; fused on mill; excellent mill feed, roll |
| | tack; hot strength; very good blanket; FR 28 psi |
| 84 | 15 min mix; very dry mix; MT 290° F.; fused on mill; excellent mill feed; |
| | very good roll tack; good blanket; fair hot strength; brittle blanket; FR 28 psi |
| 85 | 15 min mix; very dry mix; MT 283° F.; fused on mill; excellent mill feed, hot |
| | strength; fair roll tack; very good blanket; FR 245° F. |
| 86 | 15 min mix; very dry mix; MT 285° F.; fused on mill; excellent mill feed, roll |
| | tack, blanket; good hot strength; FR 240° F. |
| 87 | 15 min mix; very dry mix; MT 285° F.; fused on mill; excellent mill feed, roll |
| | tack, blanket; very good hot strength; FR 260° F. |
| 88 | 15 min mix; very dry mix; MT 287° F.; fused on mill; excellent mill feed; fair |
| | roll tack; very brittle blanket; poor hot strength; FR 250° F. |
| 89 | 15 min mix; very dry mix; MT 290° F.; fused on mill; excellent mill feed; fair |
| | roll tack that got worse with continued milling; poor brittle blanket; good |
| | hot strength; FR 250° F. |
| 90 | 15 min mix; very dry mix; MT 284° F.; fused on mill; excellent mill feed, roll |
| | tack; fair blanket; very good hot strength; FR 230° F. |
| 91 | 15 min mix; very dry mix; MT 283° F.; fused on mill; excellent mill feed, roll |
| | tack; good blanket; very good hot strength; FR 230° F. |
| 92 | 15 min mix; very dry mix; MT 286° F.; fused on mill; excellent mill feed, roll |
| | tack; good blanket; very good hot strength; FR 235° F. |
| 93 | 15 min mix; very dry mix; MT 281° F.; fused on mill; excellent mill feed, roll |
| | tack; very good blanket, hot strength; FR 235° F. |
| 94 | 15 min mix; very dry batch; MT 281° F.; fused on mill; excellent mill feed, |
| | roll tack, blanket, hot strength; FR 230° F. |
| 95 | 15 min mix; very dry mix; MT 279° F.; fused on mill; excellent mill feed, roll |
| | tack, blanket; very good hot strength; FR 235° F. |
| 96 | 15 min mix; very dry mix; MT 279° F.; fused on mill; fair mill feed; good |
| | roll tack; fair blanket; excellent hot strength; FR 235° F. |
| 97 | 15 min mix; very dry mix; MT 273° F.; fused on mill; excellent mill feed, roll |
| | tack, blanket; hot strength; FR 235° F. |
| 98 | 12 min mix; nice lumpy mix; MT 285° F.; poor mill feed, roll tack at first, |
| | but improved with repeated milling; excellent blanket, hot strength; FR |
| | 235° F. |
| 99 | 15 min mix; very dry mix; MT 287° F.; fused on mill; excellent mill feed; |
| | very good roll tack, blanket; good hot strength; FR 245° F. |
| 100 | 15 min mix; very dry mix; MT 272° F.; fused on mill; excellent mill feed; |
| | very good roll tack; good blanket; very good hot strength; FR 240° F. |
| 101 | 15 min mix; very dry mix; MT 272° F.; fused on mill; excellent mill feed; |
| | good roll tack; poor, very brittle blanket; very good hot strength; FR 235° F. |
| 102 | 16 min mix; fused in mixer with small lumps, slightly dry; MT 290° F.; |
| | excellent mill feed, roll tack; very good blanket; fair hot strength; FR 234° F. |
| 103 | 15 min mix; very dry mix; MT 284° F.; fused on mill; excellent mill feed; |
| | very good roll tack; fair blanket; poor hot strength; FR 244° F.; BR 307° F. |
| 104 | 15 min mix; very dry mix; MT 283° F.; fused on mill; excellent mill feed; |
| | very good roll tack; poor blanket, hot strength; FR 244° F.; BR 307° F. |
| 105 | 15 min mix; very dry mix; MT 283° F.; fused on mill; excellent mill feed, roll |
| | tack; poor blanket, hot strength; FR 244° F.; BR 307° F. |
| 106 | 15 min mix; very dry mix; MT 283° F.; fused on mill; excellent mill feed, roll |
| | tack, blanket, hot strength; FR 244° F.; BR 307° F. |
| 107 | 15 min mix; very dry mix; MT 284° F.; fused on mill; very good mill feed; |
| | excellent roll tack, blanket, hot strength; FR 245° F.; BR 310° F. |
| 108 | 15 min mix; very dry mix; MT 280+° F.; fused on mill; excellent mill feed, |
| | roll tack, blanket; hot strength; FR 244° F.; BR 309° F. |
| 109 | 15 min mix; very dry mix; MT 283° F.; fused on mill; excellent mill feed, roll |
| | tack; very good blanket; good hot strength; FR 244° F.; |
| 110 | 15 min mix; very dry mix; MT 280+° F.; fused on mill; excellent mill feed; |
| | good roll tack, blanket; very good hot strength; FR 254° F. |
| 111 | Mottle line all fresh; mix time 17 min; MT 265° F. (read out); very nice |
| | lumpy mix; excellent mill feed; very good roll tack, blanket; good hot |
| | strength; FR 230° F. |
| 112 | 15 min mix; very dry mix; MT 283° F.; fused on mill; excellent mill feed; |
| | very good roll tack; fair blanket; poor hot strength; FR 250° F.; BR 305° F. |
| 113 | 15 min mix; very dry mix; MT 280° F.; fused on mill; excellent mill feed, roll |
| | tack, blanket, hot strength; FR 240° F.; BR 305° F. |
| 114 | 15 min mix; very dry mix; MT 282° F.; fused on mill; excellent mill feed, roll |
| | tack, blanket, hot strength; FR 250° F.; BR 305° F. |
| 115 | 15 min mix; very dry mix; MT 283° F.; fused on mill; excellent mill feed, roll |
| | tack, blanket, hot strength; FR 260° F.; BR 305° F. |
| 116 | 15 min mix; very dry mix; fused on mill; excellent mill feed; good roll tack; |
| | very good blanket; fair hot strength; FR 251° F.; BR 305° F. |
| 117 | 15 min mix; MT 277° F.; very dry mix; fused on mill; excellent mill feed, roll |
| | tack, blanket, hot strength; FR 251° F.; BR 305° F. |
| 118 | 15 min mix; very dry mix; MT 287° F.; fused on mill; excellent mill feed, roll |
| | tack; very poor blanket, hot strength; FR 250° F.; BR 305° F. |
| 119 | 18 min mix; lumpy slightly dry mix; MT 287° F.; excellent mill feed, roll |
| | tack; good blanket; fair hot strength; FR 250° F.; BR 305° F. |
| 120 | 15 min mix; very dry mix; MT 286° F.; fused on mill; excellent mill feed, roll |
| | tack; very good blanket, hot strength; FR 250° F.; BR 305° F. |
| 121 | 25 min mix; very dry mix; MT 285° F.; fused on mill; good mill feed, roll |
| | tack; very poor blanket; no hot strength; FR 243° F.; BR 308° F. |
| 122 | 25 min mix; lumpy slightly dry mix; MT 293° F.; good mill feed; fair roll |
| | tack; poor blanket; very poor hot strength; FR 241° F.; BR 309° F. |
| 123 | 24 min mix; lumpy slightly dry mix; MT 291° F.; good mill feed; very good |
| | roll tack, blanket, hot strength; FR 241° F.; BR 309° F. |
| 124 | 24 min mix; lumpy slightly dry mix; MT 292° F.; very good mill feed, roll |
| | tack; poor blanket, hot strength; FR 242° F.; BR 309° F. |
| 125 | 24 min mix; lumpy mix; MT 291° F.; very good mill feed; excellent roll tack; |
| | very good blanket, hot strength; FR 242° F.; BR 309° F. |
| 126 | 24 min mix; lumpy slightly dry mix; MT 292° F.; good mill feed; very good |
| | roll tack; good blanket, hot strength; FR 242° F.; BR 309° F. |
| 127 | 27 min mix; very dry mix; MT 296° F.; fused on mill; excellent mill feed; |
| | very good roll tack; poor blanket, hot strength; FR 242° F.; BR 309° F. |
| 128 | 25 min mix; very dry mix; MT 292° F.; fused on mill; excellent mill feed; |
| | very good roll tack, blanket, hot strength; FR 242° F.; BR 309° F. |
| 129 | 24 min mix; very dry mix; MT 287° F.; fused on mill; very good mill feed; |
| | fair roll tack; poor blanket; no hot strength; FR 238° F.; BR 311° F. |
| 130 | 24 min mix; very dry mix; MT 293° F.; fused on mill; very good mill feed; |
| | good roll tack; poor blanket; very poor hot strength; FR 243° F.; BR 311° F. |
| 131 | 24 min mix; very dry mix; MT 291° F.; fused on mill; excellent mill feed; |
| | good roll tack; poor blanket, hot strength; FR 235° F.; BR 311° F. |
| 132 | 27 min mix; lumpy slightly dry mix; MT 295° F.; good mill feed, roll tack; |
| | poor blanket, hot strength; FR 238° F.; BR 311° F. |
| 133 | 27 min mix; very dry mix; MT 294° F.; fused on mill; good mill feed, roll |
| | tack; poor blanket, hot strength; FR 238° F.; BR 311° F. |
| 134 | 27 min mix; very dry mix; MT 291° F.; fused on mill; very good mill feed, |
| | roll tack; fair blanket; poor hot strength; FR 238° F.; BR 311° F. |
| 135 | 24 min mix; lumpy slightly dry mix; MT 291 F; fair mill feed; very good roll |
| | tack; fair blanket, hot strength; FR 238° F.; BR 311° F. |
| 136 | processed normally on mottle line; 292° F. Mix temp |
| 137 | processed well on mottle line; 293° F. Mix temp; front roll temp 240° F. |
| 138 | processed well on mottle line; 290° F. Mix temp; front roll temp 240° F. |
| 139 | processed well on mottle line; 293° F. mix temp; front roll temp 240° F. |
| 140 | processed well on mottle line; 291° F. mix temp; front roll temp 240° F. |
| 141 | 15 min mix; very dry mix; MT 291° F.; fused on mill; excellent mill feed, roll |
| | tack, blanket, hot strength; FR 36 psi |
| 142 | 15 min mix; very dry mix; MT 284° F.; fused on mill; excellent mill feed; |
| | very good roll tack, hot strength; good blanket; FR 36 psi |
| 143 | 15 min mix; very dry mix; MT 287° F.; fused on mill; excellent mill feed; |
| | very good roll tack; fair blanket; good hot strength; FR 36 psi |
| 144 | 15 min mix; very dry mix; MT 287° F.; fused on mill; excellent mill feed, roll |
| | tack, blanket, hot strength; FR 245° F. |
| 145 | 15 min mix; very dry mix; MT 288° F.; fused on mill; excellent mill feed, roll |
| | tack, blanket, hot strength; FR 245° F. |
| 146 | 15 min mix; very dry batch; MT 272° F.; fused on mill; excellent mill feed, |
| | roll tack, blanket, hot strength; FR 240° F. |
| 147 | 15 min mix; very dry batch; MT 268° F.; fused on mill; excellent mill feed, |
| | roll tack, blanket; very good hot strength; FR 260° F. |
| 148 | 15 min mix; very dry batch; excellent mill feed, roll tack, blanket; very |
| | good hot strength; FR 220° F.; had to mill repeatedly due to low front roll |
| | temperature |
| 149 | MT 290° F.; very nice looking mix; good roll tack and edge bands; processed |
| | well through the dicer |
| 150 | very nice looking mix; MT 290° F.; good mill feed, roll tack, edge bands, |
| | blanket; fed well through the dicer |
| 151 | nice looking mix; MT 290° F.; very intermittent mill feed; fair roll tack; poor |
| | edge bands; required hydrocarbon resin to feed and keep edge bands; |
| | processing fair through the dicer |
| 152 | very nice looking mix; MT 290° F.; good mill feed; excellent roll tack; fair |
| | edge bands; excellent blanket; very good processing through the dicer |
| 153 | very nice looking mix; MT 290° F.; excellent mill feed, roll tack, blanket; |
| | good edge bands; processed well through the dicer |

BR = Back Roll Temperature,
FR = Front Roll Temperature,
MT = Mix Temperature

1. A fused composition consisting essentially of binder, filler and optional pigment, wherein the binder consists essentially of polyvinyl chloride homopolymer, acrylic polymer, plasticizer and stabilizer, wherein the filler and pigment comprises at least 77% by weight of the composition.

2. The fused composition of claim 1, wherein the filler and pigment comprises at least 84% by weight of the composition.

3. The fused composition of claim 1, wherein the filler and pigment comprises about 84 to about 86 by weight of the composition.

4. The fused composition of claim 1, wherein the fused composition is in the form of a tile.

5. The fused composition of claim 1, wherein the fused composition is in the form of a chip.

6. The fused composition of claim 1, wherein the acrylic polymer is selected from the group consisting of methyl acrylate, ethyl acrylate, butyl acrylate, methyl methacrylate, ethyl methacrylate, butyl methacrylate, and mixtures and copolymers thereof.

7. The fused composition of claim 1, wherein the polyvinyl chloride homopolymer comprises 0.9% to 10.5% by weight of the composition.

8. The fused composition of claim 1, wherein the acrylic polymer comprises 0.2% to 4.0% by weight of the composition.

9. The fused composition of claim 8, wherein the acrylic polymer comprises 0.4% to 2.0% by weight of the composition.

10. The fused composition of claim 1, wherein the binder comprises about 9% to about 16.5% by weight of the composition.

11. The fused composition of claim 1, wherein the composition further consists of an additional additive selected from the group consisting of a tackifier resin, an acrylic impact modifier, a polymeric filler, and combinations there of.

12. The fused composition of claim 11, wherein the tackifier resin is selected from the group consisting of a hydrocarbon resin, an alpha-methyl styrene resin, and combinations thereof.

13. The fused composition of claim 1, wherein the composition further consists of polyvinyl butryal.

14. The fused composition of claim 1, wherein the composition further consists of a polyvinyl chloride copolymer.

15. The fused composition of claim 1, wherein the composition is substantially free of a polyvinyl chloride copolymer.

16. The fused composition of claim 1, wherein at least some of the filler or binder is post consumer or post industrial.
